(19) United States
(12) Patent Application Publication
(10) Pub. No.: US 2025/0286952 A1
(43) Pub. Date: Sep. 11, 2025

(54) CALL SCRIPT MODIFICATION USING A TROUBLESHOOTING LOG

(71) Applicant: Lenovo Enterprise Solutions (Singapore) Pte Ltd., Singapore (SG)

(72) Inventors: Gary D. Cudak, Raleigh, NC (US); Michael J Miller, Federal Way, WA (US); Wayne L Fusman, JR., Monroe, WA (US); David Feisthammel, Snoqualmie, WA (US); Andreina Vivas Thomas, Seattle, WA (US)

(21) Appl. No.: 18/595,547

(22) Filed: Mar. 5, 2024

(51) Int. Cl. H04M 3/51

(52) U.S. Cl. CPC H04M 3/51

(57) ABSTRACT

A computer program product and method include monitoring one or more actions performed by a user on a computing device that are directed to troubleshoot a technical issue occurring on the computing device, storing a troubleshooting log that includes the one or more actions performed by the user, transferring the troubleshooting log to a technical support service in association with a technical support session between the user and the technical support service. The technical support service may use at least one of the actions in the troubleshooting log to satisfy at least one of a plurality of steps in a call script that is used by the technical support service to troubleshoot the technical issue.

### BACKGROUND

The present disclosure relates to systems and methods for troubleshooting a technical issue occurring in a computing device.

### BACKGROUND OF THE RELATED ART

When a computing device experiences a technical issue, a user may attempt to correct the technical issue by taking one or more actions that they are familiar with. For example, the user may restart the computing device or close some application programs that are not being used. However, if these actions are unsuccessful, the user may determine that it is necessary to call a technical support service (also referred to as a “help desk”). For example, the technical support service may be provided by the manufacturer of the computing device that is experiencing the technical issue.

Technical support services and help desk operations are expensive for the manufacturer or warranty provider. Accordingly, it is desirable to implement processes and procedures that can be used to reduce the cost of these services. Furthermore, a prompt and efficient resolution of a trouble ticket may increase customer satisfaction and loyalty. Scripting software may be used to implement a call script flow that includes a series of predetermined troubleshooting steps that should be performed on the device experiencing the technical issue. A technical support staff member with a low level of training or experience may guide the user through a call script flow to identify and troubleshoot the technical issue. The use of the call script makes the interaction relatively efficient and prevents a useful troubleshooting step from being overlooked.

### BRIEF SUMMARY

Some embodiments provide a method comprising monitoring one or more actions performed by a user on a computing device that are directed to troubleshoot a technical issue occurring on the computing device, storing a troubleshooting log that includes the one or more actions performed by the user, transferring the troubleshooting log to a technical support service in association with a technical support call between the user and the technical support service, and using at least one of the actions in the troubleshooting log to satisfy at least one of a plurality of steps in a call script that is used by the technical support service to troubleshoot the technical issue.

Some embodiments provide a computer program product comprising a non-volatile computer readable medium and non-transitory program instructions embodied therein, the program instructions being configured to be executable by a processor to cause the processor to perform various operations. The operations comprise detecting an alert indicating that a technical issue has occurred on a computing device, monitoring one or more actions performed by a user on a computing device that are directed to troubleshooting the technical issue on the computing device, storing a troubleshooting log that includes the one or more actions performed by the user, and transferring the troubleshooting log to a technical support service.

Some embodiments provide a computer program product comprising a non-volatile computer readable medium and non-transitory program instructions embodied therein, the program instructions being configured to be executable by a processor to cause the processor to perform various operations. The operations comprise receiving a troubleshooting log that identifies one or more actions performed by a user on computing device that are directed to troubleshoot a technical issue occurring on the computing device, identifying an active telephone call with the user for troubleshooting the technical issue, and using a call script to manage the active telephone call with the user, wherein the call script includes a plurality of steps for troubleshooting the technical issue. The operations further comprise associating the troubleshooting log with the active telephone call and using at least one of the one or more actions identified in the troubleshooting log to satisfy at least one of the plurality of steps in a call script.

### BRIEF DESCRIPTION OF THE SEVERAL VIEWS OF THE DRAWINGS

FIG. 1 is a diagram of a system in which a troubleshooting log may be collected by a computing device and transferred to a technical support service for altering a call script used during a technical support call.

FIG. 2 is a diagram illustrating how a troubleshooting log may be used to modify a call script.

FIG. 3 is a diagram of a smartphone.

FIG. 4 is diagram of a computer that may perform various operations in accordance with some embodiments.

FIG. 5 is a flowchart of operations of a method.

FIG. 6 is a flowchart of operations of a computing device.

FIG. 7 is a flowchart of operations of a technical support service computer.

### DETAILED DESCRIPTION

Some embodiments provide a method comprising monitoring one or more actions performed by a user on a computing device that are directed to troubleshoot a technical issue occurring on the computing device, storing a troubleshooting log that includes the one or more actions performed by the user, transferring the troubleshooting log to a technical support service in association with a technical support call between the user and the technical support service, and using at least one of the actions in the troubleshooting log to satisfy at least one of a plurality of steps in a call script that is used by the technical support service to troubleshoot the technical issue.

The computing device may have a wide range of form factors and capabilities but should include a processor capable of executing an operating system or other application program for performing operations according to one or more embodiments. Non-limiting examples of a computing device may include a tablet computer, laptop computer, notebook computer, desktop computer, server, network switch, network router, smartphone, smart television, gaming system, automotive computer, Internet of Things (IoT) devices, peripherals such as printers, and various special purpose computers that may include an Application Specific Integrated Circuit (ASIC) or System on a Chip (SoC). Furthermore, the computing device may be a standalone device or may be implemented in a computing system with other computing devices, such as a computing cluster, network or cloud.

The technical issue with the computing device may also cover a wide range of problems with the performance of the computing device. The technical issue could be related to the operation or configuration of software and/or hardware. Hardware related technical issues for the computing system may include, without limitation, overheating, hard drive malfunction, defective random-access memory (RAM), power supply unit malfunctions or interruptions, inoperable peripherals such as keyboards, mouse and printers, no network connectivity, slow response times, inaccessible functions, defective motherboard, and BIOS problems. Software related technical issues for the computing system may include, without limitation, slow response times, error messages or warnings, crashes, freezes, data corruption, unusual system behavior, or inaccessibility of certain functions or services.

In some embodiments, the one or more actions performed by the user may include at least one action selected from a configuration change, power reset or reboot of the computer, soft reset or reboot of the computer, manual settings reset, SIM (subscriber identity module) reseat, airplane mode toggle, data toggle, and WiFi toggle. Any one or more actions performed by the user or otherwise performed on the computing device may be included in the troubleshooting log (metadata).

The technical support service is a customer service provided by a computing device manufacturer to advise and assist a user (i.e., customer or system administrator) in troubleshooting technical issues that may arise in the course of operation of the computing device. A technical support communication session may include a phone call and/or an online communication or chat. A technical support service may provide technical support that is categorized into tiers or levels to provide more efficient technical service. For example, one tiered model for technical service may include L1 Support (i.e., level one or tier one) to identify and handle relatively straightforward and simple problems, L2 Support (i.e., level two or tier two) to handle more in-depth but known problems, and L3 Support (i.e., level three or tier three) to handle advanced problems requiring expert level troubleshooting and analysis. At any of these or other levels, if any, the technical support service may utilize a scripting software application that runs on a computer or computing system operated by the technical support service. The scripting software application may guide a call center employee or an automated voice system through a series of troubleshooting steps for a particular device supported by the technical support service. For example, the technical support service may be provided by a manufacturer of computing devices, where the call script(s) are developed to troubleshoot technical issues that may occur with the computing device(s) that are produced by the manufacturer. Optionally, each model or type of computing device produced by the manufacturer could have a different call script in order to implement different troubleshooting steps associated with each model or type of computing device. The technical support service may widely publicize their phone number, email address and/or URL for online communications.

In some embodiments, the call script may be designed to perform a Root Cause Analysis (RCA) and resolve a user's technical issue. Root Cause Analysis may be implemented with different approaches, but there are some common steps. For example, RCA generally involves “gathering, organizing and analyzing” information about the technical issue. The troubleshooting log (metadata) that is gathered and provided to the technical support service regarding the user's actions on the computing device, and perhaps also system responses or status, may accelerate the Root Cause Analysis to the benefit of both the user and the technical support service.

In some embodiments, the method may further include detecting an alert indicating the occurrence of the technical issue on the computing device. Accordingly, the monitoring and the storing of the one or more actions performed by the user may be initiated in response to detecting the alert. A continuous monitoring and storing of actions may consume valuable system resources with only an occasional benefit. Monitoring and storing user actions performed on the computing device only after detecting an alert indicating the occurrence of the technical issue will limit the use of system resources to the relevant period when user actions are truly directed to troubleshooting the technical issue.

Some embodiments may implement a user activated troubleshooting mode. The method may further comprise detecting user input activating a troubleshooting mode on the computing device, wherein the monitoring and the storing of the one or more actions performed by the user are initiated by the computing device in response to detecting the user activation of the troubleshooting mode. The troubleshooting mode may be activated by user input to software running on the computing device, such as the operating system or an application program. Monitoring and storing user actions performed on the computing device only after detecting user input activating a troubleshooting mode will limit the use of system resources to those instances where the user intends to perform some of their own troubleshooting actions but, if such actions do not resolve the technical issue, they may subsequently decide to contact a technical support service for assistance in troubleshooting the technical issue.

In some embodiments, the method may further include displaying a barcode uniquely associated with the troubleshooting log and using a smartphone (or any other computing device with a camera) to scan the displayed barcode, wherein scanning the barcode enables the smartphone to obtain the troubleshooting log. Using the barcode simplifies the transfer of the troubleshooting log to the smartphone that may be used to transfer the troubleshooting log to the technical support service. The smartphone may be the same or a different smartphone that is being used or will be used to contact the technical support service. in one option, scanning the barcode with a smartphone may further cause the smartphone to perform one or more actions or prompt the user to confirm a desire to have the smartphone perform the one or more actions, such as load and/or dial a phone number directed to the technical support service and/or transfer the troubleshooting log to the technical support service. In a further option, the method may further comprise dynamically generating the barcode in response to loading a web interface to the management controller of the computing device and displaying the dynamically generated barcode on the web interface, wherein scanning the dynamically generated barcode causes the troubleshooting log for the computing device to be transferred to the smartphone for use when contacting the technical support service. This latter option may be useful for troubleshooting technical issues with a server in a rack of servers that do not have their own display screens. A user or system administrator may still use their smartphone to scan the barcode that is displayed via the web interface and obtain the troubleshooting log for transfer in association with a communication session with the technical support service. Such communication session may occur via a phone call, electronic mail, text messages (short messaging service; SMS), or online chat.

The barcode may encode various content or information. In some options, the barcode may include information pointing to a location where the troubleshooting log is stored. For example, the barcode may include a URL or a filename and directory of the computing device. In other options, the barcode may include the actual troubleshooting log and/or other information needed to perform various operations. For example, the barcode may include a phone number for contacting the technical support service and/or comma separated values that cause skipping of the at least one step of the call script accessible at the phone number.

In some embodiments, the method of collecting the user actions (metadata) for the troubleshooting log may be performed on any number of devices relevant to the technical issue and may still be transmitted to the technical support service in association with the technical support call. In one specific example, the method may further comprise monitoring one or more actions performed by the user on a second device that are directed to troubleshooting the technical issue occurring on the computing device, storing a second troubleshooting log that includes the one or more actions performed by the user on the second device, and transferring the second troubleshooting log to the technical support service in association with the technical support call between the user and the technical support service. Optionally, the second device may be a peripheral device having a connection with the computing device, such as where the peripheral device is a networking device, printer, scanner or external data storage device. In a further option, a smartphone may be used to scan a barcode that is displayed on the peripheral device and uniquely associated with the peripheral device, wherein scanning the barcode enables the smartphone to obtain the second troubleshooting log. The second troubleshooting log may be transferred and used in any manner disclosed for any other troubleshooting log. Accordingly, it is possible to transfer multiple troubleshooting logs to the technical support service, especially where the technical issue may involve troubleshooting steps on more than one device. For example, a printing problem may be localized to a computing device, localized to a printer, or manifested because of some improper configuration between the computing device and the printer.

In one example, the peripheral device may include a QR code that would allow a computing device to connect to a Uniform Resource Locator (URL) or other means, to download a troubleshooting log detailing the user actions performed on the peripheral device. The QR code may be dynamically generated whenever a page (URL) is loaded or may be a static QR code (electronic or physical) that links to the URL for the troubleshooting log(s). In one example, a cable modem may have a technical issue that leads a user to perform various troubleshooting actions, such as a power reset, soft reset, configuration refresh or changes, manual settings resets, and the like. The user may utilize their smartphone camera to scan a QR code or other barcode format secured to the cable modem, such as a sticker on the bottom of the cable modem, to connect to a URL where the smartphone may download a troubleshooting log identifying the user actions that were taken or performed on the cable modem. The smartphone can subsequently share that troubleshooting log with a technical support service.

In some embodiments, the software application may suggest or initiate collecting metadata from one or more other device, such as a peripheral device. For example, if the technical issue involves a computing device printing a document on a printer, the problem could be with either the computing device that is initiating the printing or with the printer (the peripheral device) that is the target of the print job. Accordingly, the user's troubleshooting actions on both the computing device and the printer may be relevant to the analysis of the technical issue of the print job failure.

In some embodiments, a software application running on the computing device may track and log user actions that are performed on the computing device to address a technical issue. The software application may be a module of an operating system that tracks the user actions and stores a troubleshooting log of the user actions. Alternatively, the software application may be a separate application that may interrogate parts of the operating system to track user actions and store a troubleshooting log.

In some embodiments, a structured file may be created to communicate the user actions performed on the device (i.e., the troubleshooting log). In one option, the structured file may include various information about the device itself, as well as the actions taken. Non-limiting examples of a structured file format include JavaScript Object Notation (JSON), comma-separated valued (CSV), and Extensible Markup Language (XML). For example, a structured file might include the following device identifiers and user actions performed: “Motorola One on Verizon: Reseat SIM=Yes, Hard Power=Yes, Reset Network Configuration=Yes.”

In some embodiments, the device that is the subject of the troubleshooting user actions may generate the QR code with information describing the troubleshooting user actions that have been performed. Specifically, if troubleshooting user actions were performed on a server, the server web management page for the management controller may generate the QR code for scanning by another device, such as a smartphone. However, if the smartphone is the device that is the subject of the troubleshooting user actions that have been performed, then the smartphone may directly store that the troubleshooting user actions performed and transmit the troubleshooting data to the technical support service in the same manner as if the smartphone had obtained the troubleshooting data using another device's QR code. It should be noted that the relevant troubleshooting data may be stored within the QR code, may be available at a URL identified within the QR code, or other means/location.

In some embodiments, the troubleshooting log collected and stored by the software application is provided to the technical support service in association with a support call to the technical support service. The troubleshooting log may be provided to the technical support service prior to or during a technical support call, so long as the troubleshooting log can be associated with the support call. In one option, all of the troubleshooting data collected by the software application, such as during a period that a troubleshooting mode is active, is provided to the technical support service. In another option, only the troubleshooting data that is relevant to a predetermined support call flow is provided to the technical support service or queried by the technical support service.

Some embodiments include identifying a technical support service or entity for the technical issue and initiating a proper method for transmitting the metadata to the identified technical support service/entity. For example, the troubleshooting log may be transferred to the identified technical support service via text message, email, uploading to a designated URL and the like. When the user makes a phone call to a particular technical support service (also known as a “helpdesk”) that is relevant to the particular device, the user may also initiate transfer of any relevant files, such as the recently downloaded troubleshooting log. While the troubleshooting log may be automatically transferred to the technical support service, embodiments could have a configurable setting on the smartphone for selecting between automatic file transfer, transfer files subject to user approval, and transfer only manually selected files.

Some embodiments provide a computer program product comprising a non-volatile computer readable medium and non-transitory program instructions embodied therein, the program instructions being configured to be executable by a processor to cause the processor to perform various operations. It should be appreciated that the processor may be included in a computing that is experiencing a technical issue. The operations comprise monitoring one or more actions performed by a user on a computing device that are directed to troubleshooting a technical issue on the computing device, storing a troubleshooting log that includes the one or more actions performed by the user, and transferring the troubleshooting log to a technical support service.

In some embodiments, the operations may further comprise detecting an alert indicating that a technical issue has occurred on a computing device. Accordingly, the monitoring of the one or more actions and the storing of the troubleshooting log may be performed in response to detecting the alert.

In some embodiments, the operations may further comprise detecting user input initiating a troubleshooting mode. The monitoring of the one or more actions and the storing of the troubleshooting log may be initiated in response to detecting the user activation of the troubleshooting mode. An operating system or software application may detect the user input and initiate the troubleshooting mode by monitoring the one or more actions and the storing of the troubleshooting log.

In some embodiments, the operations may further comprise dynamically generating a barcode in response to loading a web interface to the management controller of the computing device and displaying the barcode on the web interface. Scanning the barcode causes the troubleshooting log for the computing device to be transferred to a device, such as a smartphone that has scanned the barcode, for use when placing a phone call to the technical support service.

In some embodiments, the computing device is a smartphone, and the operations further comprise initiating an active phone call with the technical support service, wherein the troubleshooting log is transferred to the technical support service during the active phone call. For example, the troubleshooting log may be transferred to the same phone number used to initiate the active phone call, perhaps as an attachment to a text message.

Some embodiments provide a computer program product comprising a non-volatile computer readable medium and non-transitory program instructions embodied therein, the program instructions being configured to be executable by a processor to cause the processor to perform various operations. It should be appreciated that the processor may be included in a technical support service computer that is responsible for executing scripting software to support a technical support session via phone call or online communication. The operations comprise receiving a troubleshooting log that identifies one or more actions performed by a user on computing device that are directed to troubleshoot a technical issue occurring on the computing device, identifying an active telephone call with the user for troubleshooting the technical issue, and using a call script to manage the active telephone call with the user, wherein the call script includes a plurality of steps for troubleshooting the technical issue. The operations further comprise associating the troubleshooting log with the active telephone call and using at least one of the one or more actions identified in the troubleshooting log to satisfy at least one of the plurality of steps in a call script.

In some embodiments, during the active telephone call with the user, the call script may skip at least one of the plurality of steps in the call script that is satisfied by the at least one of the one or more actions identified in the troubleshooting log. For example, if the troubleshooting log identified an action that is required by one of the steps in the call script, then that step of the call script is satisfied and may be skipped.

In some embodiments, wherein the one or more actions performed by the user that are stored in the troubleshooting log may include at least one action selected from a configuration change, power reset of the computer, soft reset of the computer, manual settings reset, and subscriber identity module reseat.

In some embodiments, the operation of associating the troubleshooting log with the active telephone call may include identifying a first identification code via the active phone call, identifying a second identification code within the troubleshooting log, and associating the troubleshooting log with the active phone call in response to the second identification code matching the first identification code. Optionally, the troubleshooting log and the active phone call may be associated by the troubleshooting log being transferred to the technical support service from the same phone number or phone session.

Some embodiments may include dynamically altering the technical support call flow implemented by the technical support service based on, or responsive to, the content of the troubleshooting log (metadata) received by the technical support service. For example, the support call flow may be dynamically altered by skipping one or more steps in the support call flow based on the troubleshooting lot indicating that an action or task required by one or more steps of the call script have already been performed on the computing device experiencing the technical issue. Furthermore, the troubleshooting log may include the conditions or status of the computing device after performing a troubleshooting task so that the troubleshooting log includes both the action taken and the condition of the device subsequent to the action.

For example, a technical support service center computer may run a call center scripting software that guides a technical support person through a step-by-step process for troubleshooting a technical issue. Each step may include a scripted statement or description of a task that a user should perform on the device that is the subject of the troubleshooting effort. However, if the user has already performed these actions, then portions of the script may introduce unnecessary duplication of time and effort. Accordingly, the technical support service center computer may receive the user's troubleshooting log over the Internet at a URL specific to the technical support service center computer, via text message (SMS) or other sideband protocol/channel in association with the user's phone call to the technical support service. For example, the troubleshooting log may be associated with a phone call by virtue of being transferred during the call, being transferred from the same phone number, being associated with a call center reference number for the call, or other manner of association. Once the technical support service center computer has received the troubleshooting log from the user, the call center scripting software may use the troubleshooting log as input so that a particular step in the script may be skipped or otherwise modified if the troubleshooting log indicates that a particular user action that has already been performed.

The scripting software application may compare the validated user actions or steps in the received troubleshooting log to the technical support call script and may automatically alter the call script flow or update a table of steps taken to expedite the progression through the call script. For example, if the troubleshooting log indicates that a first user action has already been taken or performed, and that first action satisfies a first step in the call script, then the scripting software application may automatically advance the call script to the second step. As another example, if the troubleshooting log indicates that all user actions described in one call script (or one branch of a call script) have already been taken, then the scripting software application may advance to another call script (or another branch of the call script).

The foregoing computer program products may further include program instructions for implementing or initiating any one or more operations of the methods described herein. Similarly, the methods described herein may include any of the operations of the computer program products. Sill further, systems described herein may further perform the operations of the computer program products and/or the methods described herein.

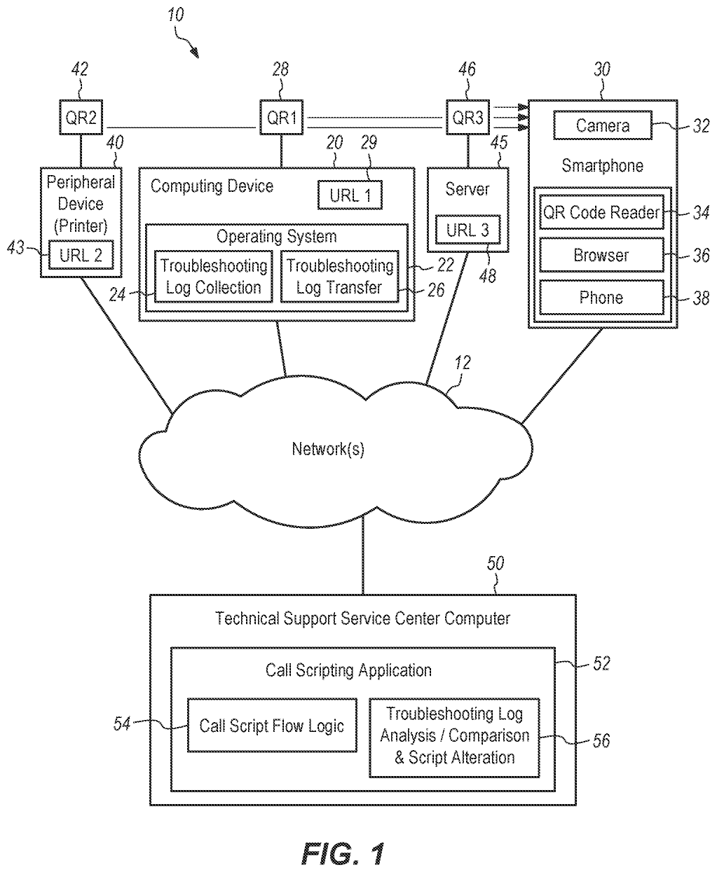

FIG. 1 is a diagram of a system 10 in which a troubleshooting log may be transferred to a technical support service 50 for altering a call script used during a technical support call. A computing device 20 has an operating system 22 or software application that includes a troubleshooting log collection module 24 and a troubleshooting log transfer module 26. The operating system or other software 22 may monitor the operation of the computing device 20 and user actions taken on the computing device 20. The troubleshooting log collection module 24 may monitor and user actions in a troubleshooting log and the troubleshooting log transfer module 26 may transfer the troubleshooting log to another device. To facilitate the transfer, the operating system 22 may generate a quick-response (QR) two-dimensional matrix barcode (“QR1”) 28 including, for example, URL1 29 where the troubleshooting log may be accessed or obtained.

A smartphone 30 having a camera 32 and a QR code reader 34 may scan the QR code 28 are decode the URL1 28. Using a browser 36, the smartphone 30 may access and download the troubleshooting log to the smartphone 30. A phone module 38 of the smartphone 30 may be subsequently used to initiate a phone call to a technical support service (associated with the technical support service center computer 50) to obtain assistance troubleshooting a technical issue occurring on the computing device 20. In association with the phone call or other manner of technical support session, the troubleshooting log may be transferred to the technical support service center computer 50.

The smartphone 30 may be similarly used to obtain troubleshooting logs from the peripheral device 40 and/or the server 45. As shown, the peripheral device 40 may display a QR code (“QR2”) 42 that encodes the URL2 43 wherein a troubleshooting log for the peripheral 40 and the server 45 may display a QR code (“QR3”) 46 that encodes the URL3 48 where a troubleshooting log for the server 45 may be obtained. The smartphone 30 may be used to obtain the troubleshooting logs of any one or more instances of the computing device 20, the peripheral device 40 and the server 45. Furthermore, the smartphone 30 may also form a troubleshooting log of user actions taken to troubleshoot a technical issue occurring on the smartphone 30. Subsequently, the smartphone 30 may transfer any one or more of the troubleshooting logs to the technical support service center computer 50 in association with a technical support session, such as a technical support phone call.

During a technical support session, the technical support service center computer 50 may execute a call scripting application 52. The call scripting application 52 defines a call script flow logic 54 that may be specific to a particular device type or model. For example, the call script flow for the computing device 20 or peripheral device 40 may include different steps than the call script flow for the server 45. Furthermore, the call scripting application 52 includes a troubleshooting log analysis/comparison and script alteration module 56 that receives any troubleshooting log that is submitted by the smartphone 30 and alters the call script flow to reflect any of the user actions identified in the troubleshooting log that satisfy any of the steps of the call script flow. This comparison and alteration is described further in reference to FIG. 2.

FIG. 2 is a diagram illustrating how a troubleshooting log 60 may be used to modify a call script 55. The troubleshooting log 60 received from Source B, such as the smartphone, identifies that a Device A has experienced a technical issue. The troubleshooting log 60 includes a table, list or other data structure that identifies user actions already taken on Device A to troubleshoot the technical issue. During a technical support session with Source B, the technical support service center computer 50 may select and execute the call script 55 that includes steps for troubleshooting a technical issue for a device type or model consistent with Device A. Furthermore, an identifier for Source B may be used to associate the troubleshooting log 60 with the active technical support session for which the call script 55 is being performed.

The technical support service center computer 50 then applies the user actions (five shown) in the troubleshooting log 60 against the steps (seven shown) in the call script 55. In this example, steps of the call script that have already been performed, as evidenced by the troubleshooting log, may be skipped. While a technical support session that did not have an associated troubleshooting log would proceed sequentially from step 1 to step 7 without skipping any steps, the troubleshooting log 60 associated with the call script 55 allows the call script flow to skip steps 1-2 and 4-6. Accordingly, the net call script flow will include step 1 (“Network setting reset”; original step 3) and step 2 (“Move to Level 2”; original step 7). The use of the troubleshooting log to simplify, shorten or otherwise modify the call script flow saves time and effort without any sacrifice in the thoroughness of the troubleshooting steps in the call script.

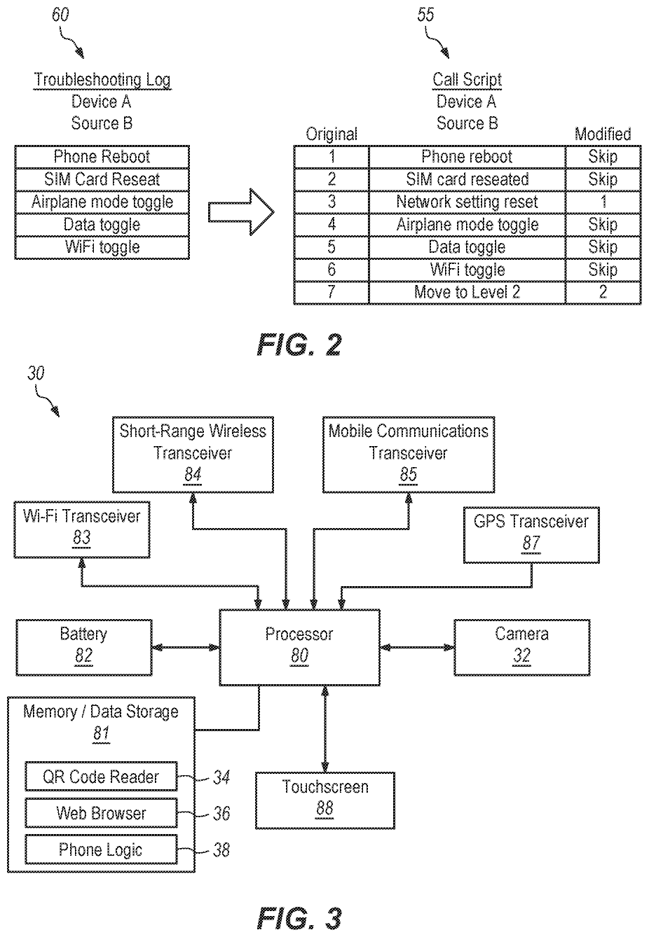

FIG. 3 is a diagram of the smartphone 30 according to one embodiment. The smartphone 30 may include a processor 80, memory or data storage device 81, a battery or other energy storage device 82, a camera or other input and/or output device 86. The smartphone 30 may further include a touchscreen 88, short-range wireless transceiver 84, a wireless local area network transceiver (“Wi-Fi transceiver”) 83, a mobile communication transceiver 85 for communication with a cellular communication network, and a global positioning system (GPS) transceiver 87.

The memory 81 may store one or more applications including program instructions that are executable by the processor 80. Such applications may include the QR code reader 34, the web browser 36, and the phone logic module 38. While not shown, the smartphone will also include an operating system and may also include applications that perform the same or similar operations as the troubleshooting log collection module 24 and troubleshooting log transfer module 26 described in reference to the computing device 20 (not shown; see FIG. 1).

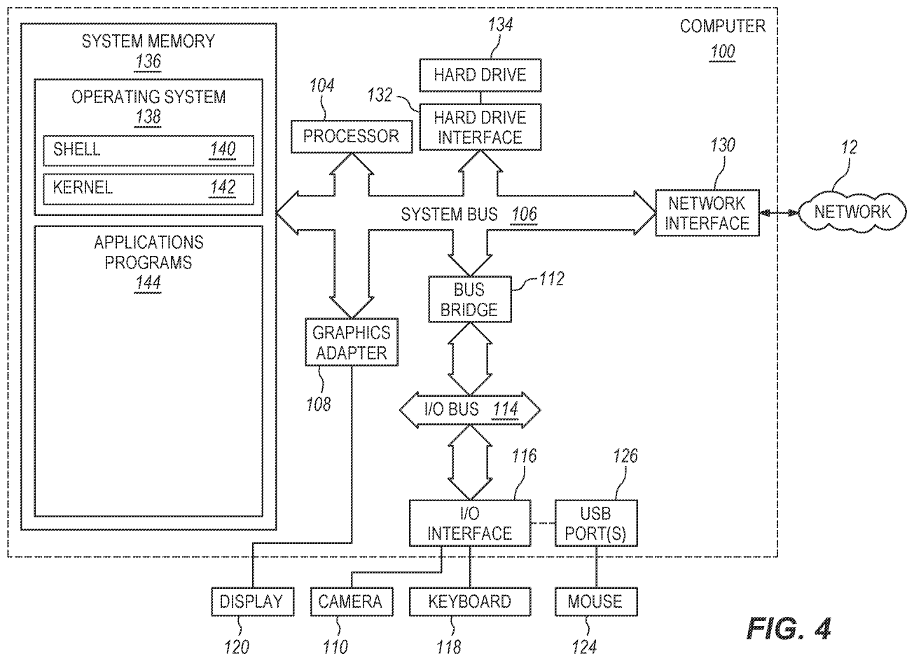

FIG. 4 is diagram of a computer 100 that may be representative of the computing device 20, the server 45 and/or the technical support service center computer 50 in accordance with some embodiments. The computer 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a camera 110, a keyboard 118 (such as a touch screen virtual keyboard), and a USB mouse 124 via USB port(s) 126 (or other type of pointing device, such as a trackpad). As depicted, the computer 100 is able to communicate with other devices over the network 12 using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as the lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144. Depending upon whether the computer 100 is serving as the computing device 20, the server 45 and/or the technical support service center computer 50, the application programs 144 may include logic or applications to implement any of the embodiments disclosed herein.

The operating system 138 for the computer 100 may include a shell 140 for providing transparent user access to resources such as the application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc.

As depicted, the operating system 138 also includes the kernel 142, which may include lower levels of functionality for the operating system 138, including providing essential services required by other parts of the operating system 138 and application programs 144. Such essential services may include memory management, process and task management, disk management, and mouse and keyboard management.

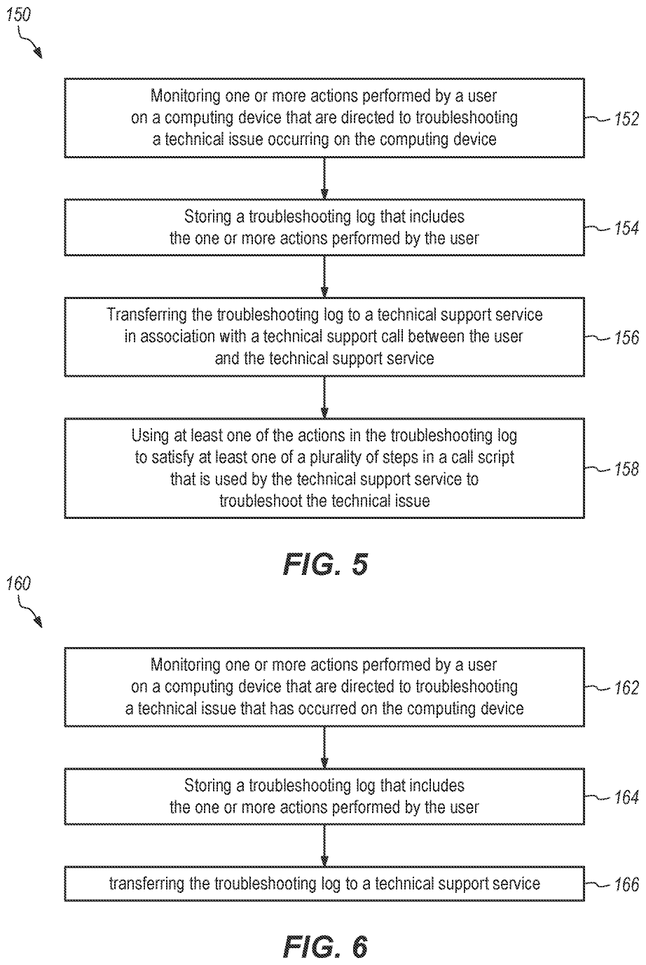

FIG. 5 is a flowchart of operations 150 of a method. Operation 152 includes monitoring one or more actions performed by a user on a computing device that are directed to troubleshoot a technical issue occurring on the computing device. Operation 154 includes storing a troubleshooting log that includes the one or more actions performed by the user. Operation 156 includes transferring the troubleshooting log to a technical support service in association with a technical support call between the user and the technical support service. Operation 158 includes using at least one of the actions in the troubleshooting log to satisfy at least one of a plurality of steps in a call script that is used by the technical support service to troubleshoot the technical issue.

FIG. 6 is a flowchart of operations 160 of a computing device. Operation 162 includes monitoring one or more actions performed by a user on a computing device that are directed to troubleshooting a technical issue that has occurred on the computing device. Operation 164 includes storing a troubleshooting log that includes the one or more actions performed by the user. Operation 166 includes transferring the troubleshooting log to a technical support service.

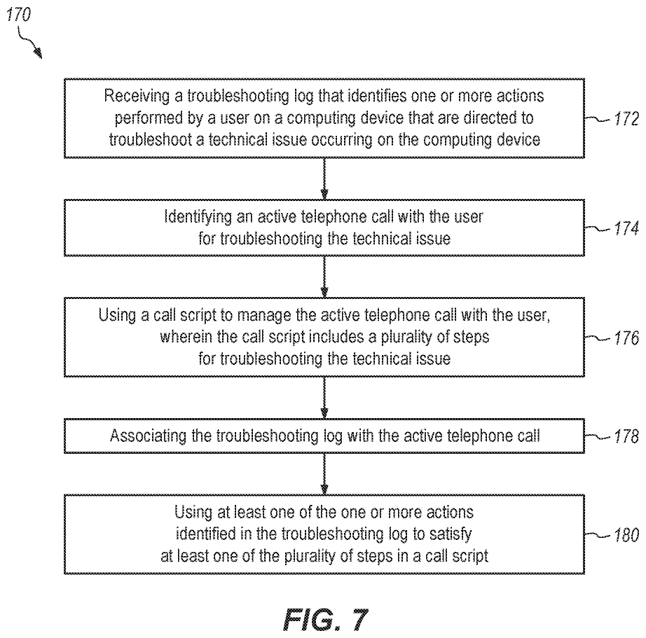

FIG. 7 is a flowchart of operations 170 of a technical support service computer. Operation 172 includes receiving a troubleshooting log that identifies one or more actions performed by a user on computing device that are directed to troubleshoot a technical issue occurring on the computing device. Operation 174 includes identifying an active telephone call with the user for troubleshooting the technical issue. Operation 176 includes using a call script to manage the active telephone call with the user, wherein the call script includes a plurality of steps for troubleshooting the technical issue. Operation 178 includes associating the troubleshooting log with the active telephone call. Operation 180 includes using at least one of the one or more actions identified in the troubleshooting log to satisfy at least one of the plurality of steps in a call script.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A method, comprising:
monitoring one or more actions performed by a user on a computing device that are directed to troubleshoot a technical issue occurring on the computing device;
storing a troubleshooting log that includes the one or more actions performed by the user;
transferring the troubleshooting log to a technical support service in association with a technical support call between the user and the technical support service; and
using at least one of the actions in the troubleshooting log to satisfy at least one of a plurality of steps in a call script that is used by the technical support service to troubleshoot the technical issue.

2. The method of claim 1, wherein the one or more actions performed by the user include at least one action selected from a configuration change, power reset of the computer, soft reset of the computer, manual settings reset, and SIM (subscriber identity module) reseat.

3. The method of claim 1, further comprising:
detecting an alert indicating the occurrence of the technical issue on the computing device, wherein the monitoring and the storing of the one or more actions performed by the user are initiated in response to detecting the alert.

4. The method of claim 1, further comprising:
detecting user input activating a troubleshooting mode on the computing device, wherein the monitoring and the storing of the one or more actions performed by the user are initiated by the computing device in response to detecting the user activation of the troubleshooting mode.

5. The method of claim 1, further comprising:
displaying a barcode uniquely associated with the troubleshooting log; and
using a smartphone to scan the displayed barcode, wherein scanning the barcode enables the smartphone to obtain the troubleshooting log.

6. The method of claim 5, further comprising:
dynamically generating the barcode in response to loading a web interface to the management controller of the computing device; and
displaying the dynamically generated barcode on the web interface, wherein scanning the dynamically generated barcode causes the troubleshooting log for the computing device to be transferred to the smartphone for use when contacting the technical support service.

7. The method of claim 5, wherein the barcode includes a phone number for contacting the technical support service and comma separated values that cause skipping of the at least one step of the call script accessible at the phone number.

8. The method of claim 1, further comprising:
monitoring one or more actions performed by the user on a second device that are directed to troubleshoot the technical issue occurring on the computing device;
storing a second troubleshooting log that includes the one or more actions performed by the user on the second device; and
transferring the second troubleshooting log to the technical support service in association with the technical support call between the user and the technical support service.

9. The method of claim 8, wherein the second device is a peripheral device having a connection with the computing device, wherein the peripheral device is a networking device, printer, scanner or external data storage device.

10. The method of claim 9, further comprising:
using a smartphone to scan a barcode that is displayed on the peripheral device and uniquely associated with the peripheral device, wherein scanning the barcode enables the smartphone to obtain the second troubleshooting log.

11. A computer program product comprising a non-volatile computer readable medium and non-transitory program instructions embodied therein, the program instructions being configured to be executable by a processor to cause the processor to perform operations comprising:
detecting an alert indicating that a technical issue has occurred on a computing device;
monitoring one or more actions performed by a user on a computing device that are directed to troubleshooting the technical issue on the computing device;
storing a troubleshooting log that includes the one or more actions performed by the user; and
transferring the troubleshooting log to a technical support service.

12. The computer program product of claim 11, wherein the monitoring of the one or more actions and the storing of the troubleshooting log are performed in response to detecting the alert.

13. The computer program product of claim 11, the operations further comprising:
detecting user input initiating a troubleshooting mode, wherein the monitoring and the storing of the one or more actions performed by the user are initiated by the software in response to detecting the user activation of the troubleshooting mode.

14. The computer program product of claim 11, the operations further comprising:
dynamically generating a barcode in response to loading a web interface to the management controller of the computing device; and
displaying the barcode on the web interface, wherein scanning the barcode causes the troubleshooting log for the computing device to be transferred to a smartphone for use when placing a phone call to the technical support service.

15. The computer program product of claim 11, wherein the computing device is a smartphone, the operations further comprising:
initiating an active phone call with the technical support service, wherein the troubleshooting log is transferred to the technical support service during the active phone call.

16. A computer program product comprising a non-volatile computer readable medium and non-transitory program instructions embodied therein, the program instructions being configured to be executable by a processor to cause the processor to perform operations comprising:
receiving a troubleshooting log that identifies one or more actions performed by a user on computing device that are directed to troubleshoot a technical issue occurring on the computing device;
identifying an active telephone call with the user for troubleshooting the technical issue;
using a call script to manage the active telephone call with the user, wherein the call script includes a plurality of steps for troubleshooting the technical issue;
associating the troubleshooting log with the active telephone call; and
using at least one of the one or more actions identified in the troubleshooting log to satisfy at least one of the plurality of steps in a call script.

17. The computer program product of claim 16, wherein, during the active telephone call with the user, the call script skips at least one of the plurality of steps in the call script that is satisfied by the at least one of the one or more actions identified in the troubleshooting log.

18. The computer program product of claim 16, wherein the one or more actions performed by the user include at least one action selected from a configuration change, power reset of the computer, soft reset of the computer, manual settings reset, and subscriber identity module reseat.

19. The computer program product of claim 16, wherein the operation of associating the troubleshooting log with the active telephone call includes:
identifying a first identification code via the active phone call;
identifying a second identification code within the troubleshooting log; and
associating the troubleshooting log with the active phone call in response to the second identification code matching the first identification code.

20. The computer program product of claim 16, wherein the troubleshooting log is a structured file including data identifying the computing device having the technical issue and data describing the one or more actions performed by the user on the computing device.
